(19) United States
(12) Patent Application Publication
(10) Pub. No.: US 2012/0000128 A1
(43) Pub. Date: Jan. 5, 2012

(54) MODULAR HYDROPONIC GROWING UNIT

(76) Inventor: Patrick Rochefort, Deux-Montagnes (CA)

(21) Appl. No.: 13/256,107

(22) PCT Filed: Mar. 11, 2010
(86) PCT No.: PCT/CA2010/000358

§ 371 Date: Sep. 14, 2011

Related U.S. Application Data
(60) Provisional application No. 61/202,542, filed on Mar. 11, 2009.

(51) Int. Cl. A01G 31/06; A01G 25/00; A01G 31/02

(52) U.S. Cl. 47/62 R; 47/59 R

(57) ABSTRACT

A hydroponic growing unit is provided, the hydroponic growing unit comprising a substantially cylindrical frame adapted to receive a plurality of substantially vertically mounted racks therein, each rack being suitable for receiving a growing medium thereto; a light source disposed in the frame; and an irrigation system adapted to collect a fluid to a remote reservoir and draw the fluid on the growing medium.

### CROSS REFERENCE TO RELATED SPECIFICATIONS

The present application claims the benefits of U.S. provisional patent application No. 61/202,542 filed Mar. 11, 2009, entitled MODULAR HYDROPONIC GROWING UNIT, which is hereby incorporated by reference.

### FIELD OF THE SPECIFICATION

The present application generally relates to a hydroponic growing unit. More precisely, the present application relates to a modular hydroponic growing unit.

### BACKGROUND OF THE SPECIFICATION

Hydroponics is a method of growing plants using mineral nutrient solutions, without soil. Terrestrial plants may be grown with their roots in the mineral nutrient solution only or in an inert medium, such as perlite, gravel, or mineral wool.

Plant physiology researchers discovered in the 19th century that plants absorb essential mineral nutrients as inorganic ions in water. In natural conditions, soil acts as a mineral nutrient reservoir but the soil itself is not essential to plant growth. When the mineral nutrients in the soil dissolve in water, plant roots are able to absorb them. When the required mineral nutrients are introduced into a plant's water supply artificially, soil is no longer required for the plant to thrive. Almost any terrestrial plant will grow with hydroponics. Hydroponics is also a standard technique in biology research and teaching.

The two chief merits of the soilless cultivation of plants are, first, much higher crop yields, and secondly, the fact that hydroponics can be used in places where ordinary agriculture or gardening is impossible. Thus not only is it a profitable undertaking, but one which has proved of great benefit to humanity. People living in crowded city streets, without gardens, can grow fresh vegetables and fruits in window-boxes or on house tops. By means of hydroponics all such places can be made to yield a regular and abundant supply of clean, health-giving greenstuffs. Not only town dwellers, but also country residents have cause to be thankful to soilless culture. Deserts, rocky and stony land in mountainous districts or barren and sterile areas can be made productive at relatively low cost.

Other advantages include faster growth combined with relative freedom from soil diseases, and very consistent crops, the quality of produce being excellent. There is also a considerable reduction in growing area, weeds are practically non-existent, while standard methods and automatic operations mean less labor, less cost, and no hard manual work. Some plants can be raised, out of season, better control of crops naturally results in addition to no dirt and no smells. Waterlogging never occurs now.

Inert medium racks can be vertically mounted on a growing unit to use less floor space. A series of racks are mounted together, forming a cylinder, to face a light source and top irrigation is provided to each rack. Water is collected at the bottom and recirculated to the top of the rack when needed. Plants are growing horizontally in direction to the light source and naturally lead vertically further they grow.

It is difficult to have access inside a growing unit using such a vertical arrangement of inert medium racks. The number of inert medium racks is limited around the light source and it might be desirable to increase the number of inert medium racks in the unit. Odors management and water management represent a challenge that remains to be perfected.

Therefore, a need for an improved hydroponic growing unit over the existing art has been felt.

### SUMMARY OF THE SPECIFICATION

The following presents a simplified summary of the specification in order to provide a basic understanding of some aspects of the specification. This summary is not an extensive overview of the specification. It is not intended to identify key/critical elements of the specification or to delineate the scope of the specification. Its sole purpose is to present some concepts of the specification in a simplified form as a prelude to the more detailed description of exemplary embodiments, which is presented later.

A modular hydroponic growing unit of the present specification may, by way of example, be exploited in relation to domestic and industrial applications. However, the modular hydroponic growing unit of the present specification may be embodied to serve in contexts that differ from the embodiments illustrated hereinafter.

Accordingly, it is an object of the present specification to obviate or mitigate some or all of the above disadvantages.

Therefore, one other object of the present specification improves at least some of the deficiencies associated with hydroponic culture intended to be adapted to a modular hydroponic growing unit.

An object of the present specification provides a wall-less frame that is provided with a series of members defining a structure adapted to support a series of inert medium racks thereto.

One object of the present specification provides an inert medium creating a wall to the frame.

Another object of the present specification provides a frame that is shaped and designed to provide support to inert medium racks.

An additional object of the present specification provides a frame adapted to provide maximum access to the interior of the frame to garden the plants therein.

One additional object of the present specification provides a distinct irrigation fluid reservoir adapted to receive drained irrigation fluid.

An additional object of the present specification provides a modular hydroponic growing unit.

Another additional object of the present specification provides a modular hydroponic growing unit that is vertically stackable.

Another additional object of the present specification provides a ducted modular hydroponic growing unit that is adapted to draw air from the modular hydroponic growing unit.

An aspect of the present specification provides a light reflecting surface on interior portions of the modular hydroponic growing unit that are not covered by plants to reflect light to the growing plants.

An aspect of the present specification provides a top ducted light reflector.

One aspect of the present specification provides a series of wall-forming inert medium racks that, once installed on the frame, are creating a wall to the frame.

An additional aspect of the present specification provides a frame adapted to separate in halves to provide maximum access to the interior of the frame to garden the plants therein.

One other aspect of the present specification provides an inner medium racks locating gutter adapted to collect irrigation fluid therein.

One aspect of the present specification provides a gutter provided with a drain hole therein adapted to drain irrigation fluid in the gutter; the gutter being inclined to direct the irrigation fluid toward the drain hole.

An additional aspect of the specification provides supporting wheels allowing moving the hydroponic growing unit in respect with the ground, the wheels being material in opening the unit in halves.

One additional aspect of the specification provides a plurality of light sources disposed near the center of the cylindrical hydroponic growing unit.

Yet another aspect of the present specification provides a frame member adapted to receive an irrigation system thereon. The irrigation system being adapted to be installed either on the base hydroponic growing unit or on the hydroponic growing module when a hydroponic growing module is staked on the base hydroponic growing unit.

One other aspect of the present specification provides a hydroponic growing unit comprising an open structure frame adapted to receive a plurality of support members therein, each support member being adapted for receiving a growing medium and a light source disposed in the frame.

Another aspect of the present specification provides a hydroponic growing unit wherein the support members when provided with respective growing medium form a substantially closed wall for the growing unit.

One other aspect of the present specification provides the hydroponic growing unit with support members adapted to be disposed on the frame in a spaced apart relationship and that are substantially vertical.

A further aspect of the present specification provides a hydroponic growing unit comprising a frame adapted to receive a plurality of support members therein, each support member being adapted for receiving a growing medium, a light source disposed in the frame and an irrigation system adapted to irrigate the growing medium, the irrigation system including a remotely connected reservoir.

Another aspect of the present specification provides a hydroponic growing unit comprising a frame adapted to receive a plurality of support members therein, each support member being adapted for receiving a growing medium, a light source disposed in the frame and a gutter adapted to collect irrigation fluid therein from dripping growing medium.

Yet another aspect of the present specification provides the hydroponic growing unit with a gutter disposed on a lower interior portion of the frame, the gutter being adapted to channel irrigation fluid dripping from the growing medium to the remotely connected reservoir.

One other aspect of the present specification provides a hydroponic growing unit comprising a frame adapted to receive a plurality of support members therein, each support member being adapted for receiving a growing medium, a light source disposed in the frame and a reflector substantially radially disposed on the frame to reflect light from the light source.

A further aspect of the present specification provides a hydroponic growing unit comprising a frame adapted to receive a plurality of trays therein and a light source disposed in the frame.

A further yet aspect of the present specification provides the hydroponic growing unit with trays each including a body having a number of receiving openings on one of its side surfaces, an open top part and a perforated bottom part.

Other objects, aspects, advantages and features of the present specification will become more apparent upon reading of the following non-restrictive description of embodiments thereof, given by way of example only with reference to the accompanying drawings.

### BRIEF DESCRIPTION OF THE DRAWINGS

Reference will now be made to the accompanying drawings, showing by way of illustration an illustrative embodiment of the present specification, and in which:

FIG. 1 is a perspective view of an hydroponic unit;

FIG. 2 is a perspective view of the hydroponic unit of FIG. 1 in an open configuration;

FIG. 3 is a perspective view of an inert medium support rack with an inert medium;

FIG. 4 is a perspective view of the assembled inert medium with the inert medium support rack for FIG. 3;

FIG. 5 is a perspective view, partially viewed from the top, of the assembled inert medium with the inert medium support rack hung to the frame of the hydroponic unit of FIG. 1;

FIG. 6 is a side elevation perspective view of the assembled inert medium with the inert medium support rack hung to the frame of the hydroponic unit of FIG. 1;

FIG. 7 is a perspective view of an irrigation system adapted to be installed on the frame of the hydroponic unit of FIG. 1;

FIG. 8 is a side elevation perspective view of the irrigation system installed on the frame of the hydroponic unit of FIG. 1;

FIG. 9 is a top plan view of the irrigation system installed on the frame of the hydroponic unit of FIG. 1;

FIG. 10 is a perspective view of a light reflector adapted to be installed on the frame of the hydroponic unit of FIG. 1;

FIG. 11 is a perspective view of the reflecting side of the light reflector of FIG. 10;

FIG. 12 is a side elevation perspective view of the hydroponic unit with the light reflector of FIG. 10 and the irrigation system of FIG. 7;

FIG. 13 is a side elevation perspective view of an hydroponic module;

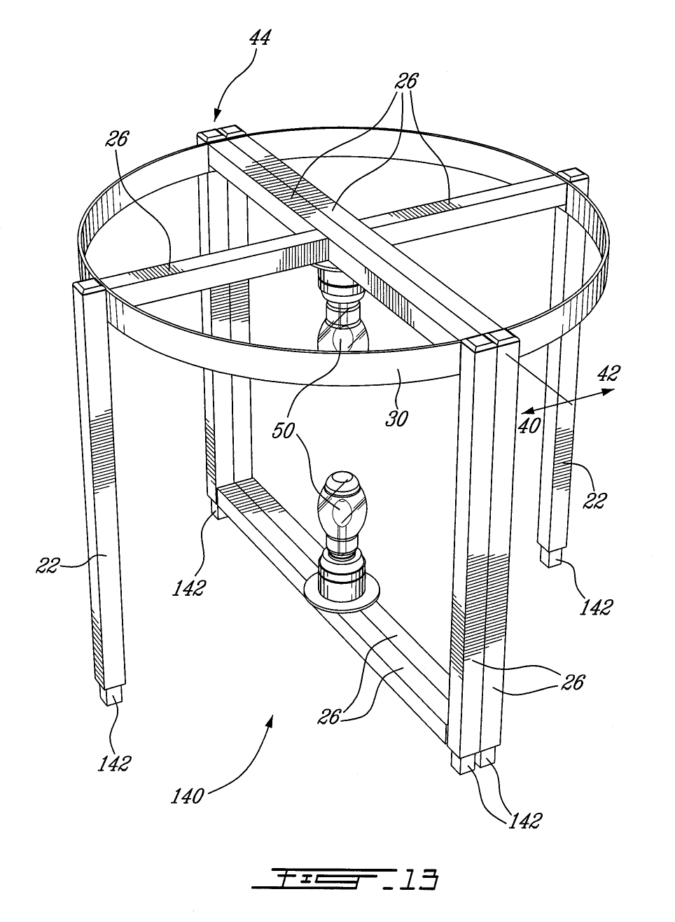

FIG. 14 is a side perspective view of the hydroponic unit with the hydroponic module of FIG. 13, the irrigation system of FIG. 7 and the light reflector of FIG. 10 installed thereon; and

FIG. 15 is a side perspective view of a support tray.

### DESCRIPTION OF ILLUSTRATIVE EMBODIMENT(S) OF THE INVENTION

The present specification will now be described with reference to the drawings, wherein like reference numerals are used to refer to like elements throughout. In the following description, for purposes of explanation, numerous specific details are set forth in order to provide a thorough understanding of the present specification. It may be evident, however, that the present specification may be practiced without these specific details.

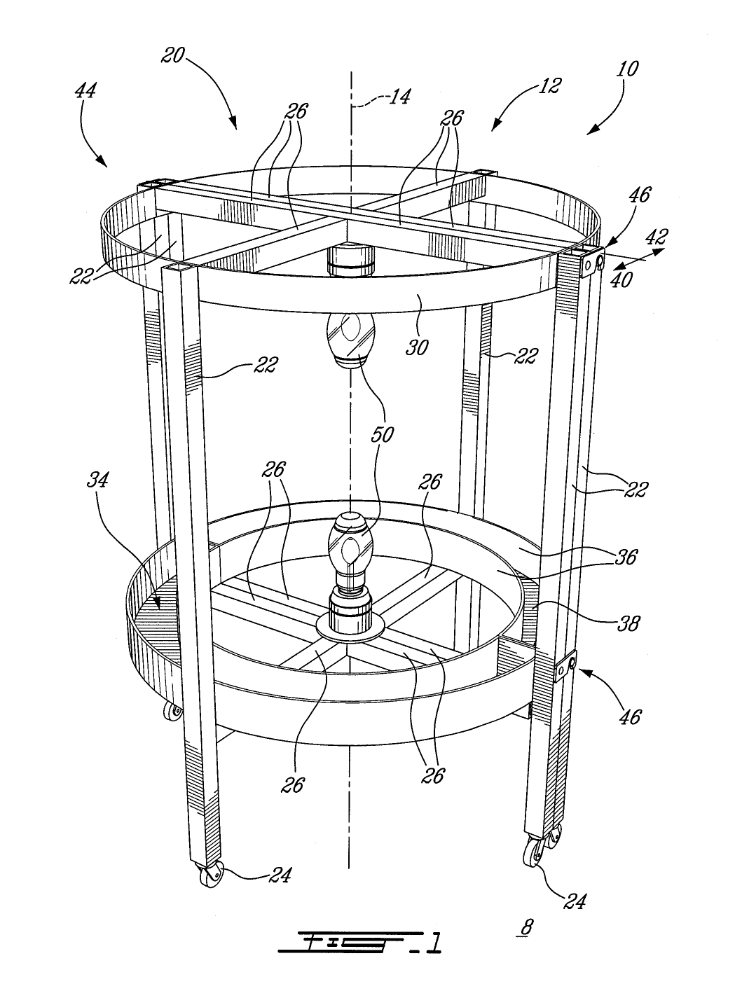

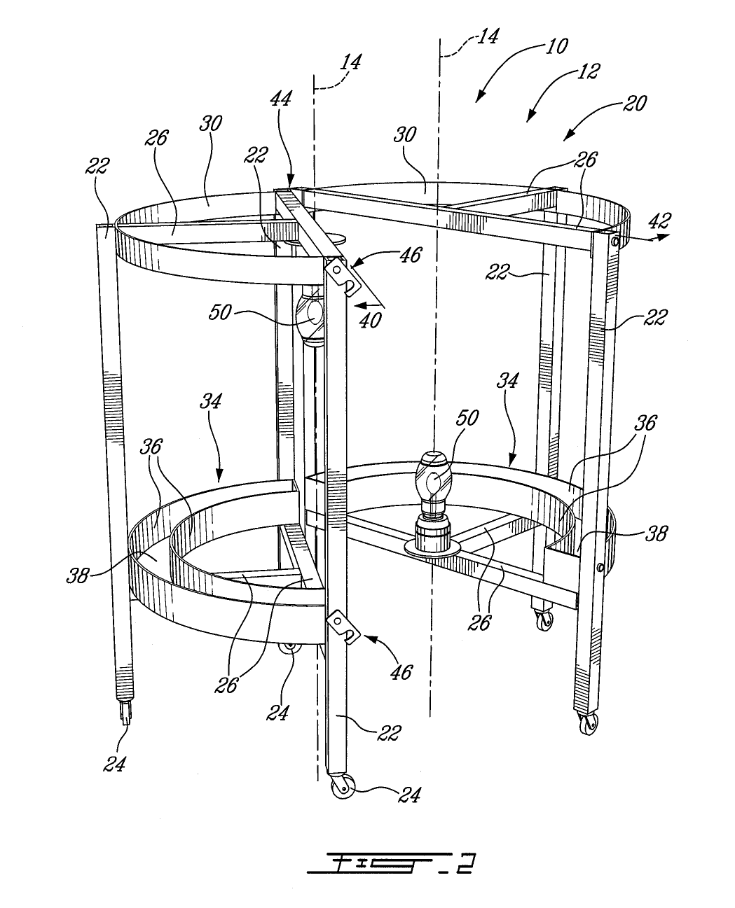

Thus, an embodiment is shown on FIG. 1 and FIG. 2 illustrating a hydroponic growing unit 10 adapted to grow plants and/or crops therein. As it can be seen, FIG. 1 depicts an empty hydroponic growing unit 10 with no plants therein. The hydroponic growing unit 10 has a cylindrical shape 12 standing vertically on the floor 8 as indicated by the cylinder axis 14. The hydroponic growing unit 10 comprises an open structure frame 20 having vertical members 22 provided with respective support wheels 24 thereunder, cross members 26 secured to, inter alia, vertical members 22 and a circular horizontal member 30 secured thereto.

The illustrative embodiment shown in the Figures is a small size version of the hydroponic growing unit 10 suitable, for instance, to grow cooking herbs. Larger versions of the illustrated hydroponic growing unit 10 adapted to grow larger plants are within the realm of the present specification. Larger versions of the hydroponic growing unit 10 are using substantially comparable elements scaled to the desired dimension. It is readily provided that three different sizes of hydroponic growing unit 10 could be used; a small version having about 50 centimeters in diameter, a medium version having about 1 meter in diameter and a large version having about 2 meters in diameter.

All structural members shown on the illustrative embodiment of FIG. 1 and FIG. 2 are made of extruded aluminum members. Aluminum is inexpensive and resists well to humidity, however, other material and other manufacturing processes that could provide comparable structures adapted to substantially achieve similar purposes are not departing from the scope of the present specification unless otherwise mentioned. Plastic molded components, composite material, steel and even wood could be used and still carry out the inventions unless otherwise mentioned.

No circumvent walls are provided per se with the frame 10 of the hydroponic growing unit 10 illustrated in the present embodiment. However, the hydroponic growing unit 10 is circumvently enclosed by wall-forming inert medium in which roots of the plants grow. How the inert medium (not illustrated on FIG. 1 and FIG. 2) is forming a wall is explained below in greater details. Alternatively, a wall member could be added to further enclose the plants in the hydroponic growing unit 10 and be within the scope of the specification unless otherwise stated or if the claimed invention is realized with a wall-less structure.

A gutter 34 is removeably disposed on a lower portion of the interior of the frame 12. The gutter 34 is provided by side walls 36 and a bottom 38 portion. The gutter 34 presented herein is made of aluminum sheet material but could be manufactured otherwise using various other materials and manufacturing processes suitable for the intended purpose.

The frame 12 is built in two halves 40 and 42 joined with a hinge 44 on one side to join the two halves 40 and 42 together and to allow separation of the halves 40 and 42 to access the interior of the hydroponic growing unit 10. A securing mechanism 46 is used to secure the other end of both halves 40 and 42 together to close the hydroponic growing unit 10.

A light source 50 is preferably disposed in the center of the frame 20 to provide the light needed by the plants. In the present situation, two opposed electric lamps 50 are illustrated although other types of light sources could be used for growing plants in the unit 10 without departing from the scope of the present specification.

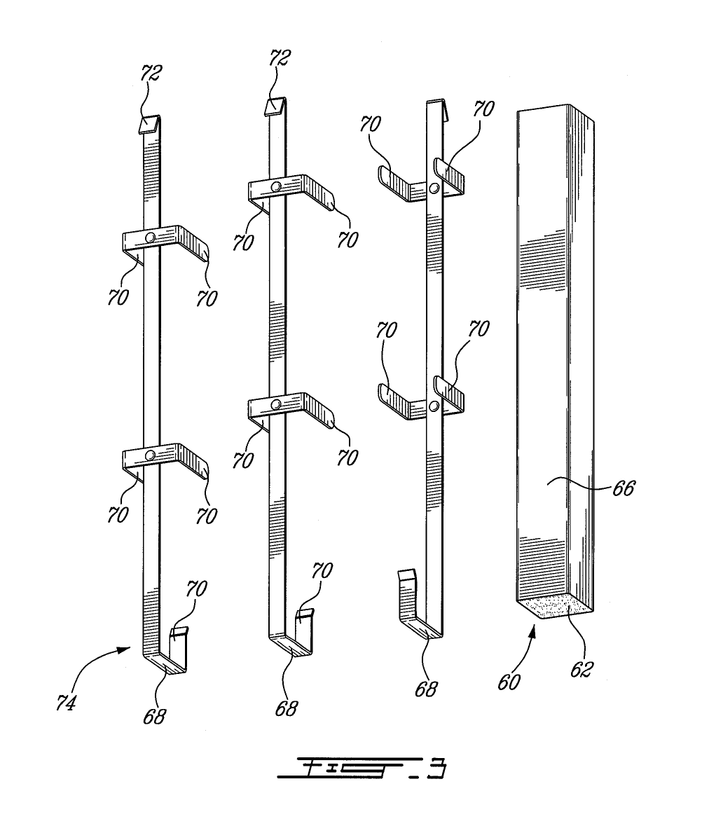

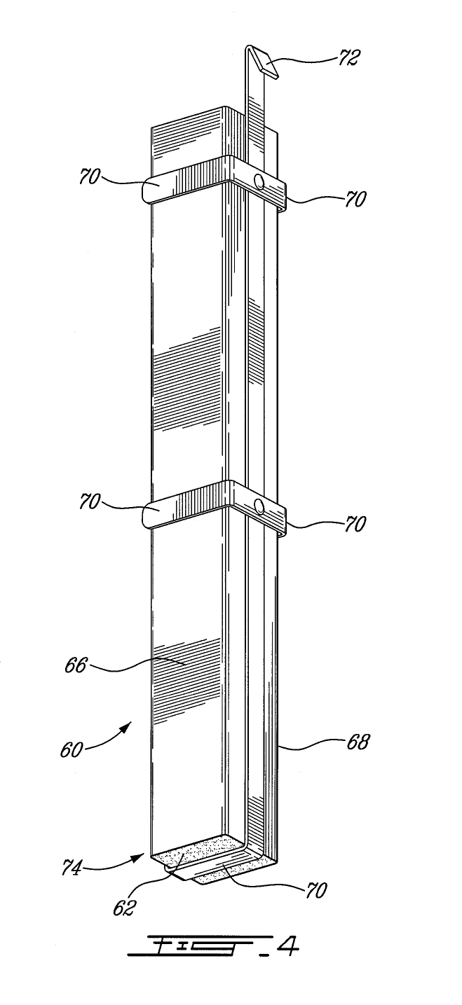

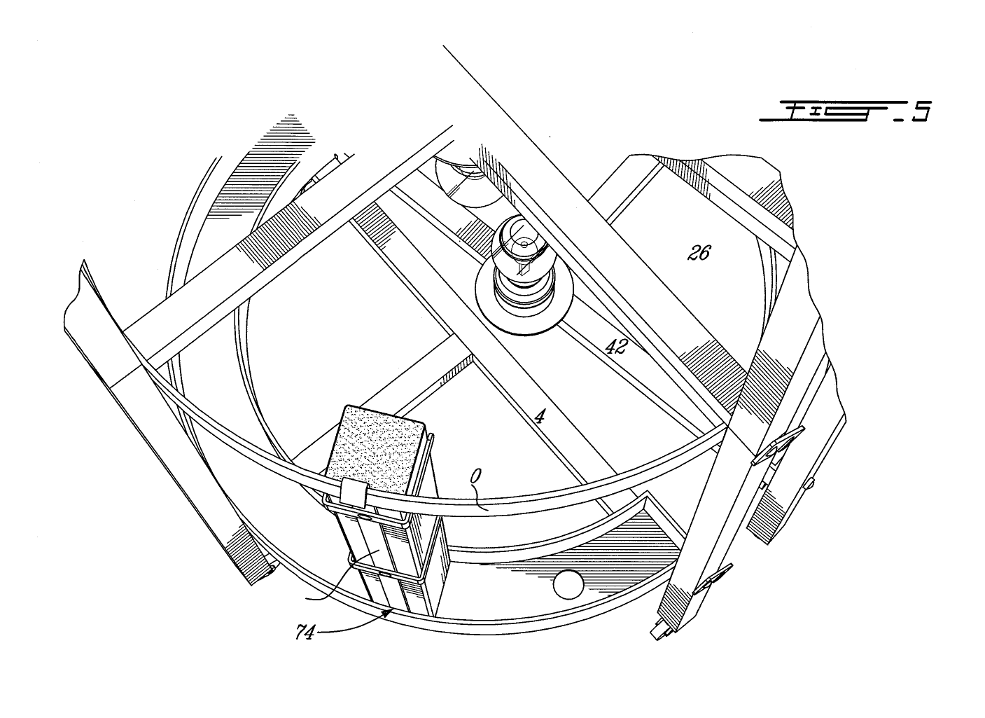

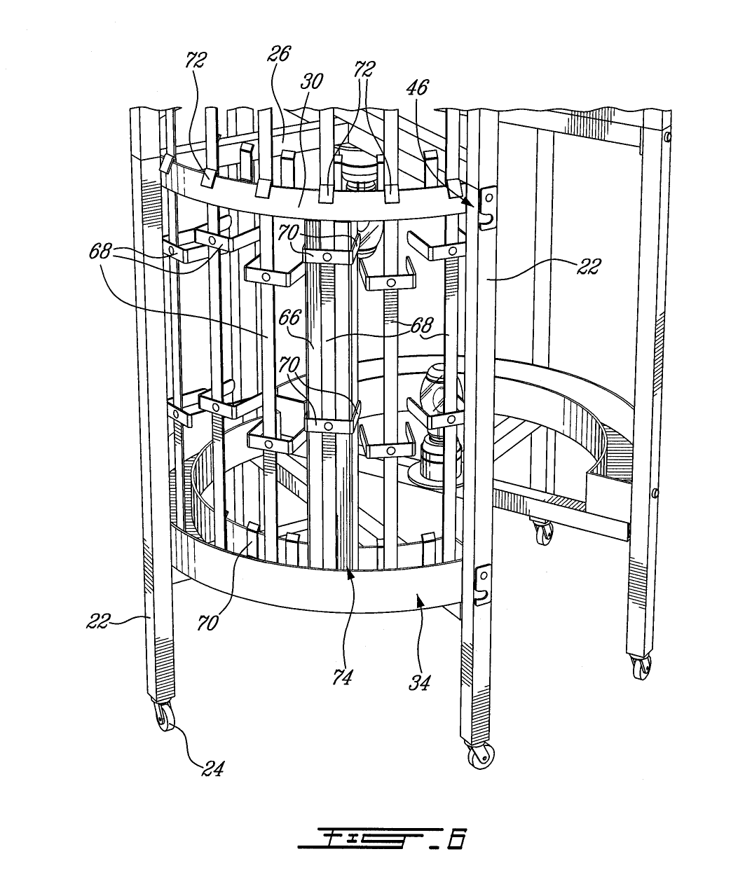

The nature of the inert medium used in a hydroponic growing unit 10 can vary and comes in several different packages as shown on FIG. 3 through FIG. 6. In the present embodiment, the inert medium is mineral wool 62 packaged in a rectangular shape 60 covered with a protective layer 66. Each package 60 of inert medium is inserted in a support member in the form of an inert medium supporting rack 68 defining a plurality of protruding supports 70 and suspender in the form of a protruding hook 72 adapted to suspend the inert medium package 60 in a vertical position to the circular horizontal member 30. A wall on the hydroponic growing unit 10 is thus created by a plurality of juxtaposed inert medium packages 60 suspended to the circular horizontal member 30 with their respective inert medium supporting rack 68. To ensure that juxtaposed inert medium packages 60 are not allowing spaced therebetween the protruding supports 70 of two adjacent inert medium packages 60 are located at different heights to prevent any direct contact therebetween and to allow direct contact of both inert medium packages 60. As it can be seen on the illustrative embodiment shown on FIG. 6, the lower portion 74 is adapted to mate with the gutter 34 to radially locate the inert medium supporting rack 68 with the frame 10.

Therefore, plants in the hydroponic growing unit 10 are growing horizontally toward a light source 50 preferably located in the middle of the growing unit 10. It can be noted that in real life plants will tend to also grow vertically against gravity in the hydroponic growing unit 10.

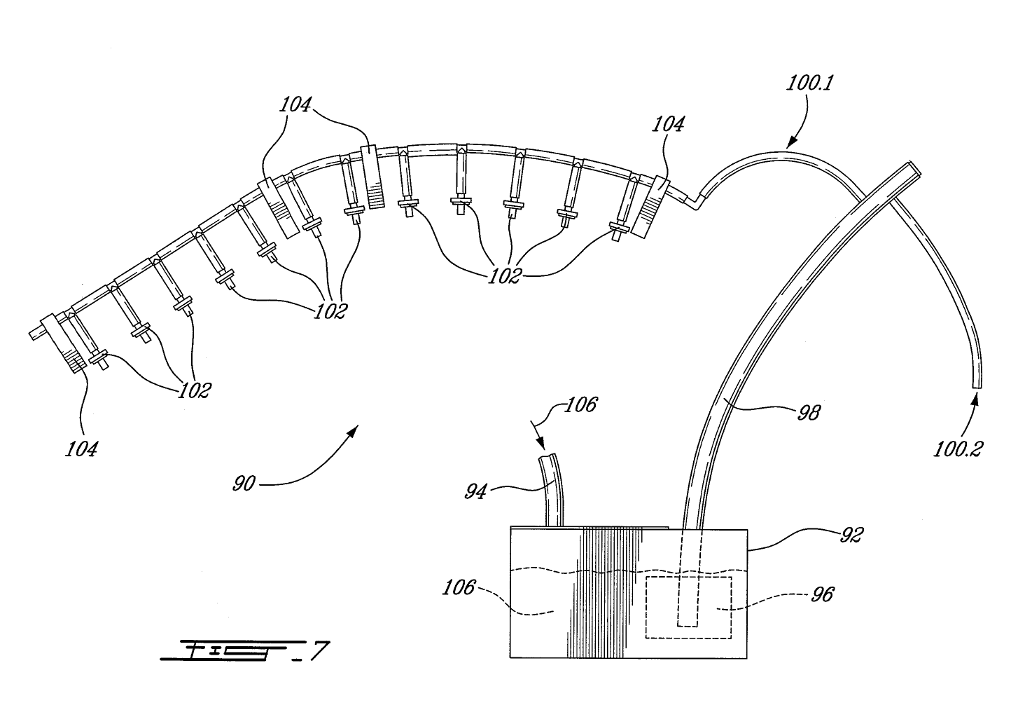

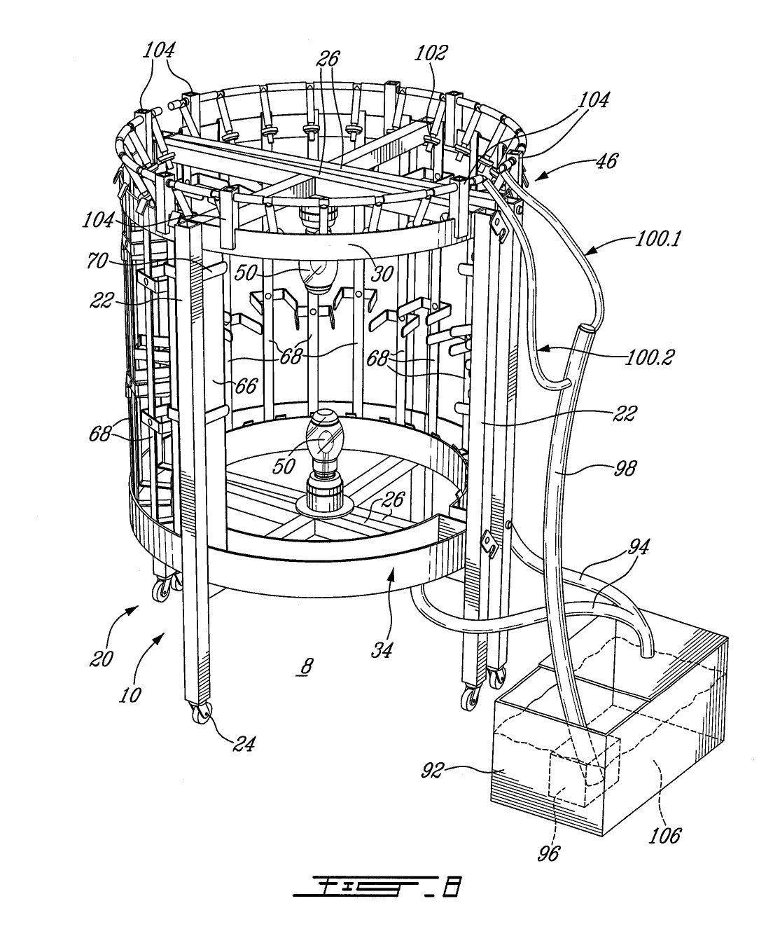

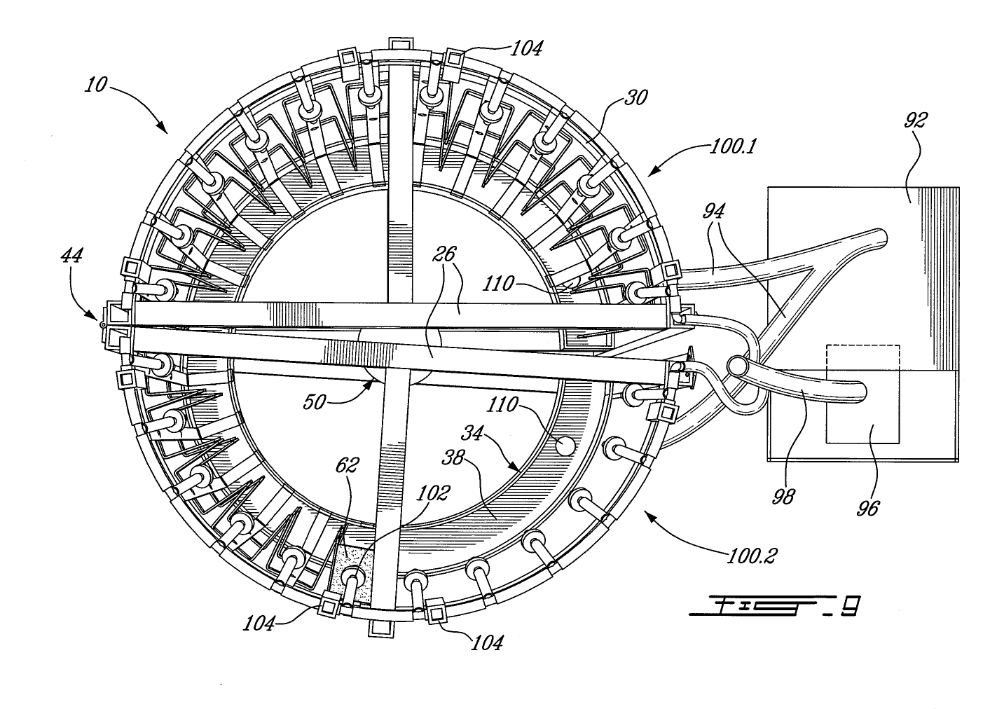

Once the inert medium is suspended in the hydroponic growing unit 10 it has to be watered to allow a plant to grow therein. An irrigation system 90 is provided to the hydroponic growing unit 10 to achieve that role. Turning now to FIG. 7 through FIG. 9 is illustrated an embodiment of the irrigation system 90 comprising a remote reservoir 92, a fluid collecting opening 94, a pump 96, a main tube 98 leading to two irrigation arms 100.1 and 100.2, one for each halve 40 and 42. Each irrigation arm 100.1 and 100.2 is provided with a series of irrigation nozzles 102 and a plurality of support members 104. The irrigation fluid 106 enters the remote reservoir 92 through the fluid collecting opening 94 and is pumped, when required, by the pump 96 through the main tube 98 to the irrigation arms 100.1 and 100.2. The irrigation fluid 106 exits the irrigation system 90 through the irrigation nozzles 102 to irrigate each package 60 of inert medium. Each irrigation nozzle 102 is positioned above its respective inert medium package 60 by the support members 104 secured to the horizontal member 30 to irrigate the package 60. The quantity of irrigation fluid is determined in function of the plant's demand and is managed by a timer managing when, how many times and for how long the irrigation system 90 will irrigate the unit 10.

Once the irrigation fluid 106 reaches the package 60 it flows through the inert medium, with gravity, and irrigates the roots of the plants disposed along the package 60. The remaining irrigation fluid 106 drains to the gutter 34, that is inclined toward the drain opening 110 to be channeled back to the remote reservoir 92 to recirculate again when required. There is preferably no irrigation fluid remaining in the gutter 34 to better control the humidity level in the growing unit 10.

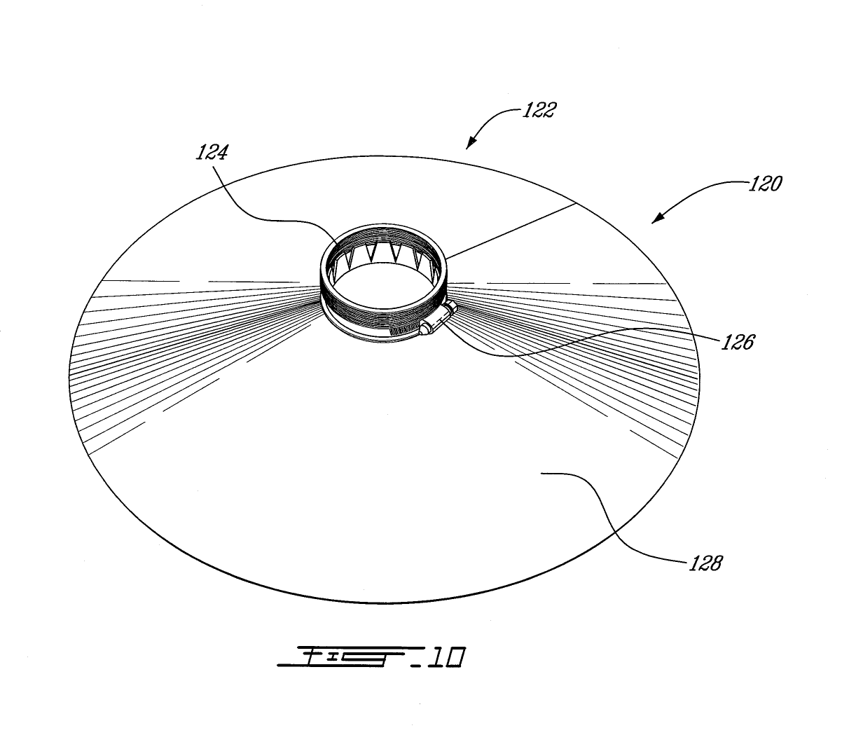

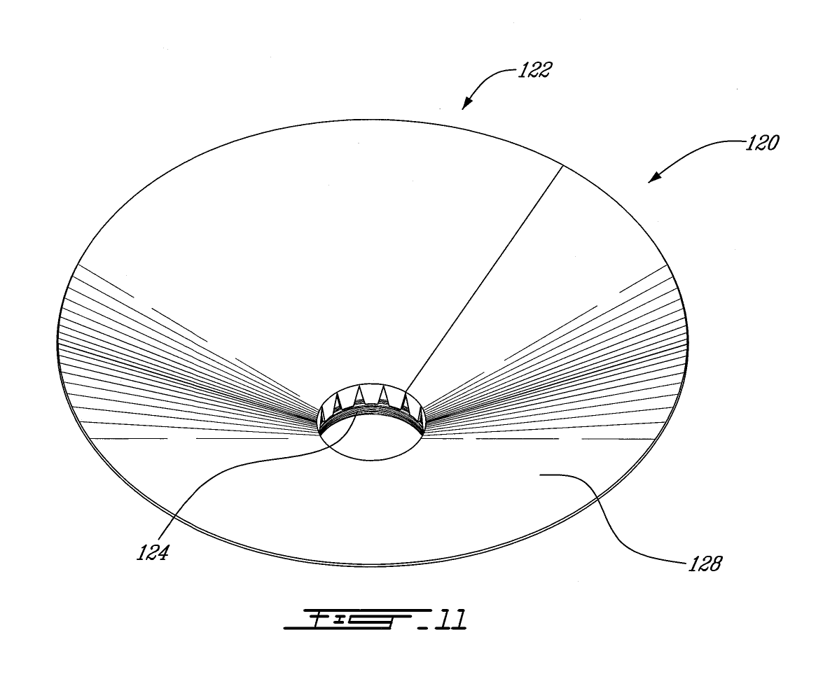

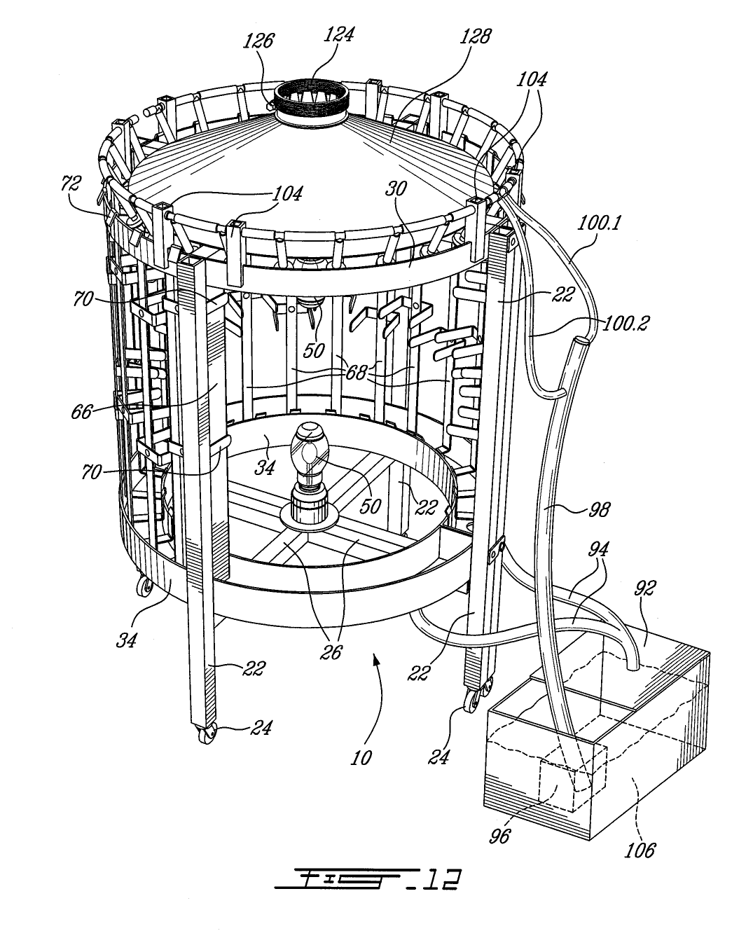

Referring to FIG. 10 through FIG. 12, in order to use wisely energy, a light reflector 120 having a frusto-conical shape is optionally installed on top of the frame 20 to reflect light from the light source 50 that is not directed toward the plants in the hydroponic growing unit 10. The light reflector 120 defines an optional opening 122 adapted to connect a ventilation duct 124 thereto to ventilate with a fan (not illustrated) the interior of the hydroponic growing unit 10 when it is required. The duct 124 is secured to the light reflector 120 with a collar 126. Polished aluminum sheet material 128 is used to build the light reflector 120 however other means and ways to build a suitable light reflector 120 can be foreseen by a skilled reader in view of FIG. 10 and FIG. 11. One can appreciate on FIG. 12 the light reflector 120 in its suggested operating position on the frame 10.

In order to efficiently use space, the present specification provides a hydroponic growing module 140 adapted to be installed on top of the frame 20 of the base hydroponic growing unit 10. The superposed hydroponic growing module 140 mates with the frame 20 of the base hydroponic growing unit 10 to become an extension of the base hydroponic growing unit 10. Because the hydroponic growing module 140 is substantially of the same diameter than the base hydroponic unit frame 20 and its vertical members 22 are disposed in substantial alignment with the vertical members 22 of the base hydroponic unit frame 20 it is possible to connect the hydroponic growing module 140 like if it was a continuity of the base hydroponic growing unit frame 20. In the present embodiment, the junction 152 between the base hydroponic growing unit 10 and the hydroponic growing module 140 is performed by inserting a lower protruding portion of each of the vertical members 22 of the hydroponic growing module 140 into corresponding vertical members 22 of the base hydroponic growing unit 10.

The hydroponic growing module 140 is advantageously of the same height as the frame 20 of the base hydroponic growing unit 10 to use the same inert medium racks 68. A gutter 34 can alternatively be adapted to the hydroponic growing module 140 to collect irrigation fluid drained from the hydroponic growing module 140 packages 60. This, of course, means that both the base hydroponic growing unit 10 and the hydroponic growing module 140 are provided with respective irrigation systems 90—that could be fluidically connected together. In contrast, a single irrigation system 90 could be installed on top of the hydroponic growing module 140 and irrigate packages 60 located in both the base hydroponic growing unit 10 and the hydroponic growing module 140. In the latter configuration it is desirable that packages 60 be aligned so that the irrigation fluid draining from an above disposed package 60 flows in the corresponding package 60 disposed underneath.

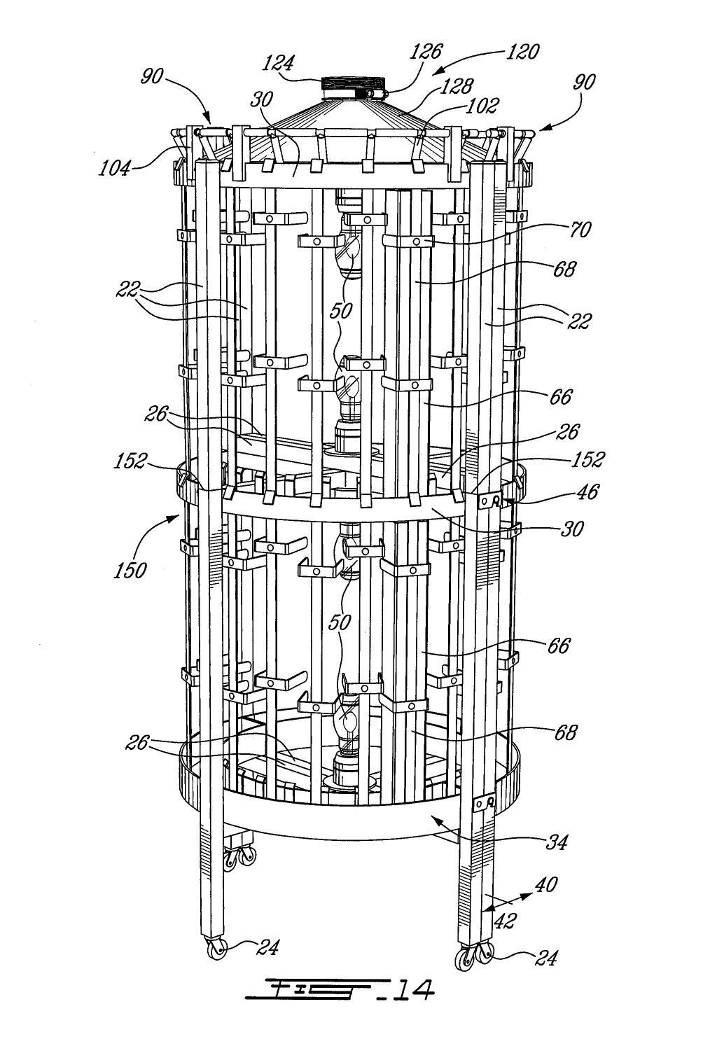

The assembled unit 150 remains capable of opening in halves 40 and 42 to allow access therein. FIG. 14 illustrates the assembled unit 150 with the light reflector 120 thereon.

It is to be understood that the hydroponic growing unit 10 may be adapted so as to stack multiple hydroponic growing modules.

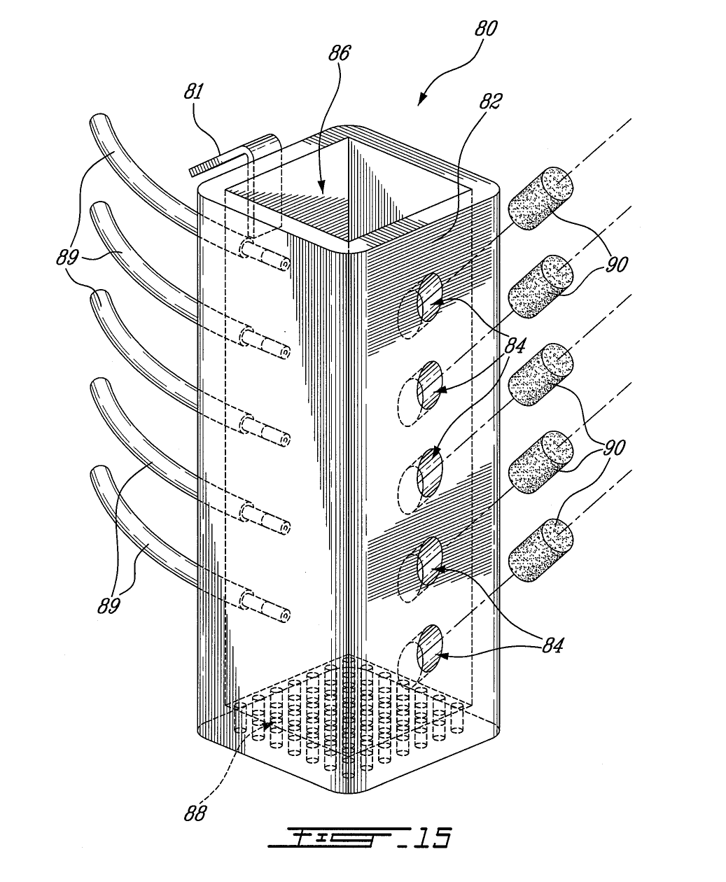

In an alternative embodiment, illustrated in FIG. 15, a support member in the form of a tray 80 may also be used with the hydroponic growing unit 10. The tray 80 includes a generally rectangular body 82 having a number of receiving openings 84 on one of its side surfaces, an open top part 86 and a perforated bottom part 88 to allow the draining of liquids. The open top part 86 allows a medium to be inserted into the tray 80 as well as allowing irrigation from the irrigation system 90. Optionally, the tray 80 may be provided with a side surface which can be opened to access the interior of the tray 80. A suspender in the form of protruding hook 81 is adapted to suspend the tray 80 in a vertical position to the circular horizontal member 30. Alternatively, the tray 80 may be adapted to be inserted into the protruding supports 70 of the supporting rack 68 and suspended in a vertical position to the circular horizontal member 30 by the protruding hook 72 of the supporting rack 68 (see FIG. 3). A wall on the hydroponic growing unit 10 is thus created by a plurality of juxtaposed trays 80 suspended to the circular horizontal member 30. It is to be understood that the shape of the tray 80 may vary.

The tray 80 may be filed, for example, with hydroton, coco, perlite, silicia or any other desired medium. Mesh baskets 90 containing peat moss, seeds or cuttings are inserted into the receiving openings 84 which are advantageously angled in a downward direction. In a further alternative embodiment, the tray 80 may be used without any medium and provided with optional nozzles 89 to spray the roots of plants inserted into the mesh baskets 90, thus in effect transforming the hydroponic growing unit 10 into an aeroponic growing unit.

It is to be understood that although the described illustrative embodiments make reference to a hydroponic growing unit 10 having a cylindrical shape, other shapes may be foreseen as well. For example, the hydroponic growing unit 10 may be rectangular, hexagonal, octagonal, etc.

The description and the drawings that are presented herein are meant to be illustrative of the present specification. They are not meant to be limiting of the scope of the present specification. Modifications to the embodiments described may be made without departing from the present specification, the scope of which is defined by the following claims:

1. A hydroponic growing unit comprising:
an open structure frame adapted to receive a plurality of support members therein, each support member being adapted for receiving a growing medium; and
a light source disposed in the frame.

2. The hydroponic growing unit of claim 1, wherein the support members when provided with respective growing medium form a substantially closed wall for the growing unit.

3. The hydroponic growing unit of claim 1, wherein the support members are adapted to be disposed on the frame in a spaced apart relationship and are substantially vertical.

4. The hydroponic growing unit of claim 1, wherein the frame is substantially cylindrical.

5. The hydroponic growing unit of claim 1, wherein the frame includes vertical members secured by cross members at bottom and top portions of the frame.

6. The hydroponic growing unit of claim 1, wherein the frame further includes a horizontal member secured to a top portion of the frame.

7. The hydroponic growing unit of claim 6, wherein the frame further includes a horizontal member secured to a top portion of the frame.

8. The hydroponic growing unit of claim 7 wherein the each support member includes a suspender adapted to suspend the support member to the horizontal member.

9. The hydroponic growing unit of claim 1, further comprising an irrigation system adapted to irrigate the growing medium.

10. The hydroponic growing unit of claim 9, wherein the irrigation system includes an irrigation nozzle associated with each of the support members.

11. The hydroponic growing unit of claim 10, wherein a respective one of the irrigation nozzles is positioned on a nozzle support member positioned above the support member being irrigated by the respective one of the irrigation nozzles.

12. The hydroponic growing unit of claim 9, wherein the irrigation system includes a remotely connected reservoir.

13. The hydroponic growing unit of claim 9, wherein the irrigation system includes a timer.

14. The hydroponic growing unit of claim 12, further comprising a gutter disposed on a lower interior portion of the frame, the gutter being adapted to channel irrigation fluid dripping from the growing medium to the remotely connected reservoir.

15. The hydroponic growing unit of claim 1, further comprising a gutter adapted to collect irrigation fluid therein from dripping growing medium.

16. The hydroponic growing unit of claim 15, wherein the gutter is removably disposed on a lower interior portion of the frame.

17. The hydroponic growing unit of claim 1, wherein the frame is adapted to open in two halves.

18. The hydroponic growing unit of claim 17, wherein the two halves are joined together by hinges on one side and are provided with a securing mechanism at an opposed side.

19. The hydroponic growing unit of claim 1, further comprising a reflector substantially radially disposed on the frame to reflect light from the light source.

20. The hydroponic growing unit of claim 19, wherein the reflector includes an opening connected to a ventilation duct.

21. The hydroponic growing unit of claim 1, further comprising a ventilation duct.

22. The hydroponic growing unit of claim 1, wherein the growing unit is a modular growing unit adapted to stack an additional frame thereon.

23. The hydroponic growing unit of claim 22, wherein the growing unit is a modular growing unit adapted to stack a plurality of additional frames thereon.

24. The hydroponic growing unit of claim 1, wherein the support members are racks defining a plurality of protruding supports.

25. The hydroponic growing unit of claim 24, wherein the growing medium is enclosed in packages adapted to be inserted into the support members.

26. The hydroponic growing unit of claim 24, further comprising trays adapted to be inserted into the support members.

27. The hydroponic growing unit of claim 1, wherein the support members are trays.

28. The hydroponic growing unit of claim 26, wherein each tray includes a body having a number of receiving openings on one of its side surfaces, an open top part and a perforated bottom part.

29. The hydroponic growing unit of claim 28, wherein the tray further includes a side surface adapted to be opened to allow access the interior of the tray.

30. The hydroponic growing unit of claim 28, wherein the openings are adapted to receive mesh baskets.

31. The hydroponic growing unit of claim 30, wherein the tray further includes nozzles for spraying roots of plants inserted into the mesh baskets.

32. The hydroponic growing unit of claim 1, wherein the support members are removable.

33. A hydroponic growing unit comprising:
a frame adapted to receive a plurality of support members therein, each support member being adapted for receiving a growing medium;
a light source disposed in the frame; and
an irrigation system adapted to irrigate the growing medium, the irrigation system including a remotely connected reservoir.

34. The hydroponic growing unit of claim 34, wherein the irrigation system includes an irrigation nozzle associated with each of the support members.

35. The hydroponic growing unit of claim 34, wherein a respective one of the irrigation nozzles is positioned on a nozzle support member positioned above the support member being irrigated by the respective one of the irrigation nozzles.

36. The hydroponic growing unit of claim 33, further comprising a gutter disposed on a lower interior portion of the frame, the gutter being adapted to channel irrigation fluid dripping from the growing medium to the remotely connected reservoir.

37. A hydroponic growing unit comprising:
a frame adapted to receive a plurality of support members therein, each support member being adapted for receiving a growing medium;
a light source disposed in the frame; and
a gutter adapted to collect irrigation fluid therein from dripping growing medium.

38. The hydroponic growing unit of claim 37, wherein the gutter is removably disposed on a lower interior portion of the frame.

39. A hydroponic growing unit comprising:
a frame adapted to receive a plurality of support members therein, each support member being adapted for receiving a growing medium;
a light source disposed in the frame; and
a reflector substantially radially disposed on the frame to reflect light from the light source.

40. The hydroponic growing unit of claim 39, wherein the reflector includes an opening connected to a ventilation duct.

41. A hydroponic growing unit comprising:
a frame adapted to receive a plurality of trays therein; and
a light source disposed in the frame.

42. The hydroponic growing unit of claim 41, wherein the each tray includes a body having a number of receiving openings on one of its side surfaces, an open top part and a perforated bottom part.

43. The hydroponic growing unit of claim 42, wherein the tray further includes a side surface adapted to be opened to allow access the interior of the tray.

44. The hydroponic growing unit of claim 42, wherein the openings are adapted to receive mesh baskets.

45. The hydroponic growing unit of claim 44, wherein the tray further includes nozzles for spraying roots of plants inserted into the mesh baskets.

46. The hydroponic growing unit of claim 41, wherein the trays are removable.
